(19) United States
(12) Patent Application Publication
(10) Pub. No.: US 2011/0030453 A1
(43) Pub. Date: Feb. 10, 2011

(54) METHOD AND APPARATUS FOR TESTING SLURRY PENETRATION THROUGH MAT FACER IN GYPSUM-BASED PANEL PRODUCTION

(76) Inventors: Michael P. Shake, Johnsburg, IL (US); Chris Lee, Mount Prospect, IL (US); Charles W. Cochran, Elkhorn, WI (US)

Correspondence Address: GREER, BURNS & CRAIN, LTD., 300 SOUTH WACKER DRIVE, SUITE 2500, CHICAGO, IL, 60603, US

(21) Appl. No.: 12/822,740

(22) Filed: Jun. 24, 2010

Related U.S. Application Data
(60) Provisional application No. 61/232,162, filed on Aug. 7, 2009.

(51) Int. Cl. G01N 15/08

(52) U.S. Cl. 73/38

(57) ABSTRACT

A method of testing penetration of a slurry through a mat facer includes the steps of placing the facer mat beneath a slurry test dispenser, storing slurry in a reservoir of the slurry test dispenser, dispensing slurry from the slurry test dispenser onto a first surface of the mat facer, allowing the slurry to harden, and observing the second surface of the mat facer for slurry penetration.

This application claims priority to provisional application Ser. No. 61/232,162 filed Aug. 7, 2009, and incorporated herein by reference in its entirety for all purposes.

### FIELD OF THE INVENTION

The present invention relates generally to devices and techniques for testing the slurry penetration through mat facer, and more specifically to an apparatus and method for testing slurry bleed through of mat facer for gypsum-based building products.

### BACKGROUND OF THE INVENTION

Gypsum-based building products are commonly used in construction. Wallboard made of gypsum is fire retardant and can be used in the construction of walls of almost any shape. Wallboard is used as an interior wall and ceiling product, and also as sheathing, roofing and shaftwall liner products. Gypsum has sound-deadening properties. It is relatively easily patched or replaced if it becomes damaged. There are a variety of decorative finishes that can be applied to the wallboard, including paint, stain and wallpaper. Even with all of these advantages, it is still a relatively inexpensive building material.

One reason for the low cost of wallboard panels is that they are manufactured by a process that is fast and efficient. A slurry, including calcium sulfate hemihydrate and water, is used to form the core, and is continuously deposited on a conveyor moving beneath a mixer. Facer materials, such as paper or glass mat, receive the slurry deposited from the mixer. Calcium sulfate hemihydrate reacts with a sufficient amount of the water to convert the hemihydrate into a matrix of interlocking calcium sulfate dihydrate crystals, causing it to set and to become firm. The continuous strip thus formed is conveyed on a belt until the calcined gypsum is set, and the strip is thereafter cut to form boards of desired length, which boards are conveyed through a drying kiln to remove excess moisture.

The amount of water added to form the slurry is in excess of that needed to complete the hydration reactions. Excess water gives the slurry sufficient fluidity to flow out of the mixer and onto the facing material to be shaped to an appropriate width and thickness. The excess water is removed from the board by evaporation. To dry the boards in a relatively short period of time, the wallboard product is usually dried by evaporating the extra water at elevated temperatures, for example, in an oven or kiln.

In glass mat facer products, if the slurry penetrates the glass mat material, the gypsum or stucco can build-up on the wallboard-forming equipment. Further, the slurry penetration through the glass mat facer can result in an unacceptable appearance of the product, and may affect the performance of the wallboard. Having slurry penetration to the panel surface may also adversely influence properties of ancillary system components to a finished assembly (e.g. cementitious basecoat, adhesives, and sealants to name a few).

Thus, it would be advantageous to have a bench test to indicate the potential for slurry penetration through a mat facer material as it may relate to a scale up manufacturing process.

### SUMMARY OF THE INVENTION

The present method of testing penetration of a slurry through a mat facer includes the steps of placing the facer mat beneath a slurry test dispenser, storing slurry in a reservoir of the slurry test dispenser, dispensing slurry from the slurry test dispenser onto a first surface of the mat facer, allowing the slurry to harden, and observing the second surface of the mat facer for slurry penetration.

A slurry test apparatus for testing the penetration of a slurry through a mat facer includes a slurry test dispenser having a body defining a reservoir. The reservoir is configured to store slurry. A bottom orifice of the body is in fluid communication with the reservoir for selectively dispensing the slurry from the reservoir. A sample mat facer is located beneath the bottom orifice and includes a top surface configured to receive the slurry. A bottom surface of the sample mat facer is opposite the top surface of the mat facer. The bottom orifice is disposed a predetermined distance above the top surface so that the emitted slurry flows directly upon the sample mat facer.

A slurry test dispenser for testing slurry includes a generally cylindrical body that defines a reservoir that is configured to store slurry. The body has a top opening for receiving the slurry. A bottom orifice is located opposite of the top opening for selectively dispensing the slurry. At least one leg is configured for supporting the body above the substrate that receives the slurry.

### BRIEF DESCRIPTION OF THE DRAWINGS

FIG. 1 is a top perspective view of a slurry test dispenser positioned above a glass mat facer in accordance with the present slurry penetration testing method;

FIG. 2 is a top perspective view of the slurry test dispenser with the slurry dispensed over a top surface of the glass mat facer in accordance with the present slurry penetration testing method; and

FIG. 3 is a comparison of the slurry penetration through a bottom surface of four sample glass mat facers in accordance with the present slurry penetration testing method.

### DETAILED DESCRIPTION OF THE PREFERRED EMBODIMENTS

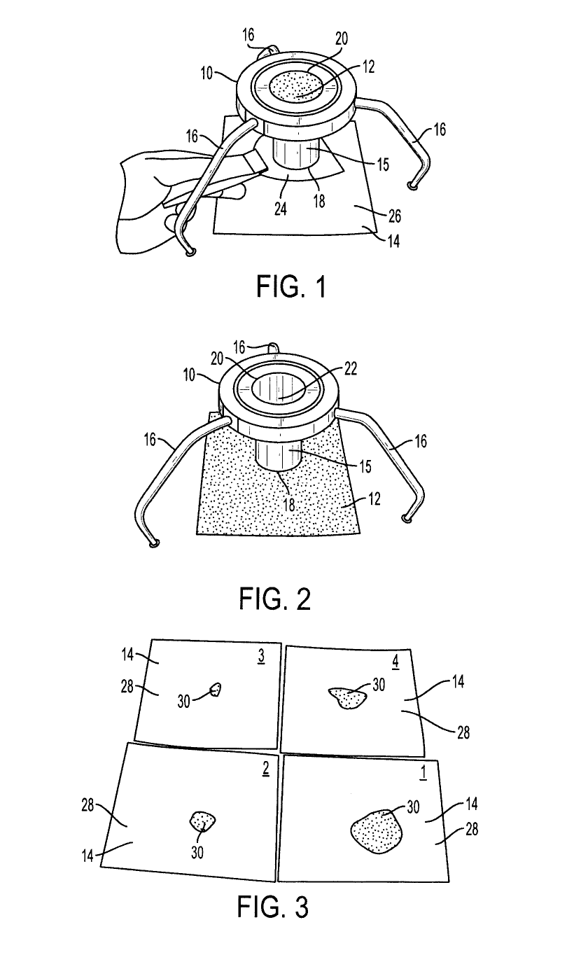

Referring to FIGS. 1-3, a slurry test dispenser is indicated generally at 10 and is shown in accordance with a method for testing penetration of a slurry 12 through a mat facer 14, for example a glass mat facer. The method can be used to indicate the performance of a specific glass mat facer 14 with a standard slurry 12, or the method can be used to indicate the performance of a specific slurry formulation for a standard glass mat facer design.

The slurry 12, for example including calcium sulfate hemihydrate and water, is used to form a wallboard (not shown). In wallboard formation, the slurry 12 is deposited on the glass mat facer 14 that moves on a conveyor (not shown) beneath a mixer (not shown). Materials forming the mat facer 14 have varying porosity, depending on the structure and the characteristics of the specific material. If the deposited slurry 12 penetrates through the porous glass mat facer 14 material, called “bleed through”, the stucco can build-up on the wallboard-forming equipment. Further, the penetration of the slurry 12 through the glass mat facer 14 can result in an unacceptable appearance of the wallboard product, and the penetration may also affect the performance of the wallboard and/or ancillary system components.

To address slurry 12 bleed through, a test method is provided that can be conducted either on-site or off-site. Initially, the test method includes the steps of taking a sample of a glass mat facer 14, for example a generally flat 7-inch by 7-inch square sample, and placing the sample glass mat facer under the slurry test dispenser 10.

It is contemplated that the slurry test dispenser 10 may be cylindrical in shape, conical in shape, or have any other shape configured to receive, store and dispense slurry 12. Dimensionally, the slurry test dispenser 10 may have a 2-inch diameter and have a 4-inch height, however other dimensions are contemplated. The slurry test dispenser 10 preferably has a generally cylindrical body 15 that is suspended or supported over the glass mat facer 14, for example about 2-inches above the glass mat facer, however other heights are contemplated.

Preferably, the slurry test dispenser 10 has at least one leg 16 that locates a bottom orifice 18 of the slurry dispenser above the substrate, in this case the glass mat facer 14. The preferred slurry test dispenser 10 has three legs 16 disposed at generally equal radial increments around the body 15. As shown, the legs 16 may extend radially away from the body 15 such that the legs are not in contact with the sample glass mat facer 14 beneath the slurry dispenser 10. Other leg orientations are contemplated. An optional annular ring attaches the at least one leg 16 to the body 15, however other configurations and methods of supporting or suspending the slurry test dispenser 10 may be used, for example a cantilevered ring stand type support.

The slurry 12 is mixed and received in the slurry test dispenser 10. The slurry 12 may be of any formulation or water/stucco ratio, for example the slurry may be a 1.1 WSR (stucco slurry having 1000 grams of stucco added to 1100 ml of water), however it should be appreciated that stuccos of varying WSR may be used with the present slurry penetration testing method, depending on the application for the slurry.

Before being received in the slurry test dispenser 10, the slurry 12 is preferably mixed in a blender (not shown), such as a Waring blender. In the blender, the gypsum or stucco preferably soaks for a period of time, for example for 10-seconds, and then is preferably mixed at a high setting for another period of time, for example for an additional 10-seconds, until the slurry is generally consistent. The resulting slurry 12 is poured into a top opening 20 of the body 15 and stored in a reservoir 22 of the slurry test dispenser 10. In the present dispenser 10, the top opening 20 is open to the atmosphere; however it is possible that a cover is optionally disposed over the top opening to cover the reservoir 22. The bottom orifice 18 is in fluid communication with the reservoir 22, and may be located on the opposite side of the reservoir from the top opening 20.

To prevent the slurry 12 from exiting the bottom orifice 18 of the slurry test dispenser 10, the bottom orifice is sealed, for example by the user holding a closure member 24, for example a taping or putty knife or other planar object in sealing engagement with the bottom orifice 18 (See FIG. 1). Alternatively, it is contemplated that a cap or a valve could be used to seal the bottom orifice 18 of the slurry test dispenser 10.

When a desired amount of slurry 12 is received in the slurry test dispenser 10, the closure member 24 is removed and the bottom orifice 18 is unsealed, allowing the slurry to fall under gravity feed to the glass mat facer 14 below. Alternatively, the slurry can be dispensed under pressure, for example with a plunger disposed in the reservoir. Further, if less than the entire amount of slurry stored in the reservoir is to be tested, the slurry can be dispensed from the bottom orifice 18 for a measured amount of time.

The bottom orifice 18 is located a predetermined distance above a top surface 26 of the sample glass mat facer 14, for example about 2-inches, so that the emitted slurry flows directly upon the sample glass mat facer. Depending on the characteristics of the glass mat facer 14, for example the porosity, and the characteristics of the slurry 12, for example the viscosity and the temperature, the slurry will penetrate from the top surface 26, through the glass mat facer 14, and to a bottom surface 28 of the mat facer (see FIG. 3).

As seen in FIG. 2, when the slurry 12 has set or hardened, the excess may be trimmed from the glass mat facer 14. Referring now to FIG. 3, the glass mat facer 14 may then be inverted, and the slurry 12 penetration through the glass mat facer may be observed by the user. The slurry 12 penetration is preferably rated comparatively by observing the depth of color of the slurry penetration or the diameter of a bleed through spot 30, created by the slurry. As seen in FIG. 3, slurry 12 was dispensed onto four sample glass mat facers 14, numbered 1, 2, 3 and 4, with varying degrees of slurry penetration through the glass mat facers. As can be seen in FIG. 3, samples 1 and 4 have greater slurry penetration than samples 2 and 3, as evidenced by the larger bleed through spots 30.

For purposes of wall board production, the lower the penetration level or the smaller the diameter of the bleed through spot 30, the better the glass mat facer 14 performs in retaining the slurry 12. Additionally, a standard glass mat facer 14 may be used to qualify and compare the viscosity of various slurries 12 having different characteristics, such as varying water stucco ratio, different plant stuccos, or varying slurry temperature.

Results of slurry penetration testing indicate that low viscosity slurries penetrate the glass mat more than high viscosity slurries, and that high temperatures, for example temperatures greater than 100-degrees Fahrenheit, have higher penetration than lower temperature slurries, for example lower than 95-degrees.

While particular embodiments of the slurry test dispenser 10 and the method for testing slurry penetration of a mat facer 14 have been shown and described, it will be appreciated by those skilled in the art that changes and modifications may be made thereto without departing from the invention in its broader aspects. Any of the options revealed herein may be used with any other option unless otherwise noted.

What is claimed is:

1. A method of testing penetration of a slurry through a mat facer, the method comprising the steps of:
placing the facer mat beneath a slurry test dispenser;
storing the slurry in a reservoir of said slurry test dispenser;
selectively dispensing the slurry from said slurry test dispenser onto a first surface of the mat facer;
allowing the slurry to harden; and
observing a second surface of the mat facer opposite of said first surface for slurry penetration.

2. The method of claim 1 wherein said slurry test dispenser is disposed approximately 2-inches (5.1 cm) above said first surface of the mat facer.

3. The method of claim 1 further comprising the step of sealing said slurry test dispenser to prevent the slurry from exiting said slurry test dispenser.

4. The method of claim 1 further comprising a bottom orifice in fluid communication with said reservoir, wherein the slurry is dispensed from said bottom orifice.

5. The method of claim 4 further comprising the step of sealing said bottom orifice to prevent the slurry from exiting said bottom orifice.

6. The method of claim 4 further comprising the step of locating said bottom orifice about 2-inches (5.1 cm) above said top surface of the mat facer.

7. The method of claim 1 further comprising the step of comparatively rating a depth of color of the slurry penetration.

8. The method of claim 1 further comprising the step of comparatively rating a diameter of the slurry penetration.

9. The method of claim 1 further comprising the step of blending the slurry prior to storing the slurry in said reservoir.

10. A slurry test apparatus for testing the penetration of a slurry through a mat facer, comprising:
a slurry test dispenser having a body defining a reservoir configured to store slurry, a bottom orifice of said body in fluid communication with said reservoir for selectively dispensing the slurry from said reservoir;
a sample mat facer located beneath said bottom orifice and including a top surface configured to receive the slurry, and a bottom surface opposite said top surface;
said bottom orifice being disposed a predetermined distance above said top surface so that the emitted slurry flows directly upon said sample mat facer.

11. The slurry test apparatus of claim 10 wherein said bottom orifice is disposed about 2-inches (5.1 cm) above said top surface.

12. The slurry test apparatus of claim 10 wherein said reservoir is open to atmosphere such that the fluid flows by gravity upon said sample mat facer.

13. The slurry test apparatus of claim 10 further comprising at least one leg configured for supporting said body above said sample mat facer.

14. The slurry test apparatus of claim 13 wherein said at least one leg further comprises three legs disposed radially around said body.

15. The slurry test apparatus of claim 10 wherein said body has a generally cylindrical shape having about a 2-inch (5.1 cm) diameter.

16. The slurry test apparatus of claim 10 wherein said body has a generally cylindrical shape having about a 4-inch (10.2 cm) height.

17. A slurry test dispenser for testing slurry comprises:
a generally cylindrical body defining a reservoir configured to store slurry, said body having a top opening for receiving the slurry;
a bottom orifice in fluid communication with said reservoir and located opposite of said top opening for selectively dispensing the slurry; and
at least one leg configured for supporting said cylindrical body above a substrate receiving the slurry.

18. The slurry test dispenser of claim 17 wherein said at least one leg further comprises three legs disposed radially around said cylindrical body.

19. The slurry test dispenser of claim 17 wherein said at least one leg supports said cylindrical body about 2-inches (5.1 cm) above the substrate receiving the slurry.

20. The slurry test dispenser of claim 17 wherein said top opening is open to the atmosphere.
